(19) United States
(12) Patent Application Publication
(10) Pub. No.: US 2002/0025363 A1
(43) Pub. Date: Feb. 28, 2002

(54) CONTAINER FOR BON-BONS

(76) Inventor: FRANS CHRISTIAAN VANGERTRUYDEN, HOESELT (BE)

Correspondence Address: FRANKLIN D WOLFFE, BANNER & WITCOFF, 1001 G STREET NW, ELEVENTH FLOOR, WASHINGTON, DC, 200014597

(21) Appl. No.: 09/380,075

(22) PCT Filed: Mar. 3, 1998
(86) PCT No.: PCT/BE98/00028

(30) Foreign Application Priority Data
Mar. 5, 1997 (BE) 9700196

(51) Int. Cl. A23G 3/00; B65D 85/00

(52) U.S. Cl. 426/115; 426/660

(57) ABSTRACT

The invention relates to a container filled with at least one bon-bon (4), which container is substantially a cylindrical can (6) which is provided with a passage for opening which allows through packed or non-packed bon-bons (1) and has substantially the same form and dimensions as drinks cans sold in vending machines. The invention also relates to a vending machine (10) having a cooled storage chamber (11) above a dispensing area (12) which is adapted to dispense cylindrical cans (6), which vending machine comprises at least one container (6) as claimed in any of the foregoing claims.

The present invention relates to a container filled with at least one bon-bon. A similar container for sweets is known from GS-A-2 130 546.

The invention provides an improvement on the known containers which has the feature according to claim 1.

Bon-bons are generally packed in a box which is given a decorative character.

In the present invention bon-bons are understood to mean luxury chocolate bob-bons, moulded bon-bons, chocolate truffles, shellfish-shaped chocolates and chocolate easter eggs or figures which may or may not be provided with a filling.

The teaching according to the present invention distances itself from this expensive approach. The shape and dimensions of the container according to the invention make the bon-bons more accessible to the consumer through the use of the already per se known vending machines for drinks cans. A container according to the invention will also increase the shelf-life and thus also the quality of bon-bons, since direct intervention is no longer required for supply of the bon-bons.

In addition to the effect of a better accessibility of bon-bons to the consumer, the present invention provides an additional advantage in respect of the quality and optimizing of the shelf-life of bon-bons.

Bon-bons should preferably be stored in a temperature range between 4° C. and 6° C. This cold chain is at present interrupted many times during handling and retailing in the usual manner.

The container according to the present invention makes it possible to avoid or at least minimize the interruptions in the cold chain whereby the bon-bons acquire a longer shelf-life, particularly when the containers according to the invention are retailed in a cooled vending machine.

From WO-A-96 05578 is known the joint vending of snacks such as crisps and drinks from a dispensing machine for drink containers. Cold drinks and such snacks are usually consumed together, whereby it may be economically advantageous to be able to sell them together. Maintaining of the cold chain for such snacks is however unimportant, in contrast to the bon-bons. Bon-bons are moreover not generally consumed together with soft drinks but with hot drinks such as coffee and tea.

Standard weights of 100 g or 250 g bon-bon will generally be present in a container according to the invention.

In the preferred embodiment of a container according to the invention a pressure prevails which is higher than 1 atm. The pressure in the can is preferably obtained with air or an inert gas. The form-rigidity of the container is improved by this overpressure prevailing in the can, whereby such a container can be applied of a thin-walled material, whereby this container is better suited for use in vending machines.

The invention also relates to a vending machine with at least one container according to the invention and having a storage chamber and a dispensing area which is adapted to dispense containers according to the invention.

Particularly in the case of bon-bons provided with dairy products, for instance whipped cream, any interruption in this cold chain is undesirable.

The storage chamber of vending machines is cooled whereby undesirable interruptions in the cold chain are minimized.

The invention will be better understood with reference to the description hereinbelow of the annexed drawings, in which:

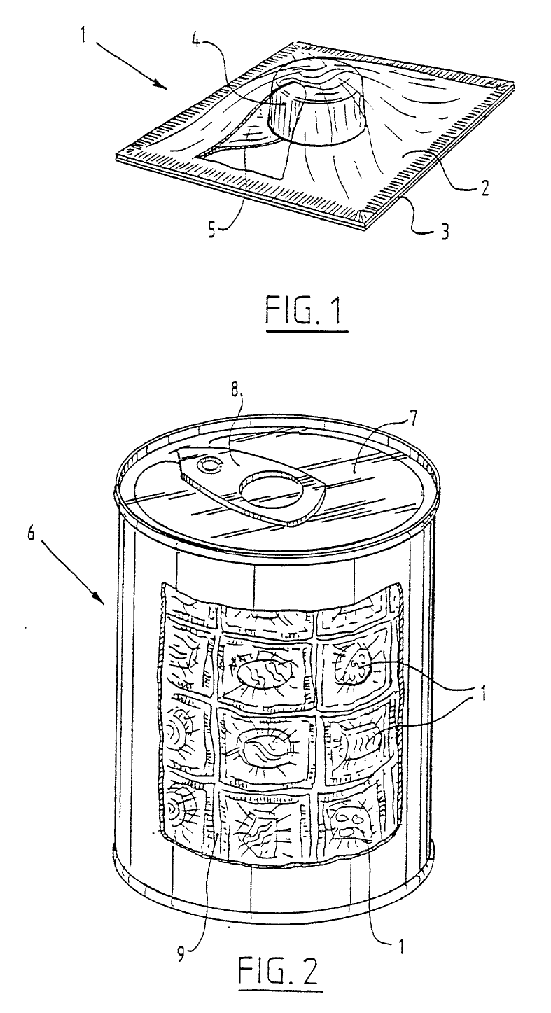

FIG. 1 shows a perspective view of an embodiment of an individually packed bon-bon;

FIG. 2 is a perspective view of a preferred embodiment of a container according to the invention; and

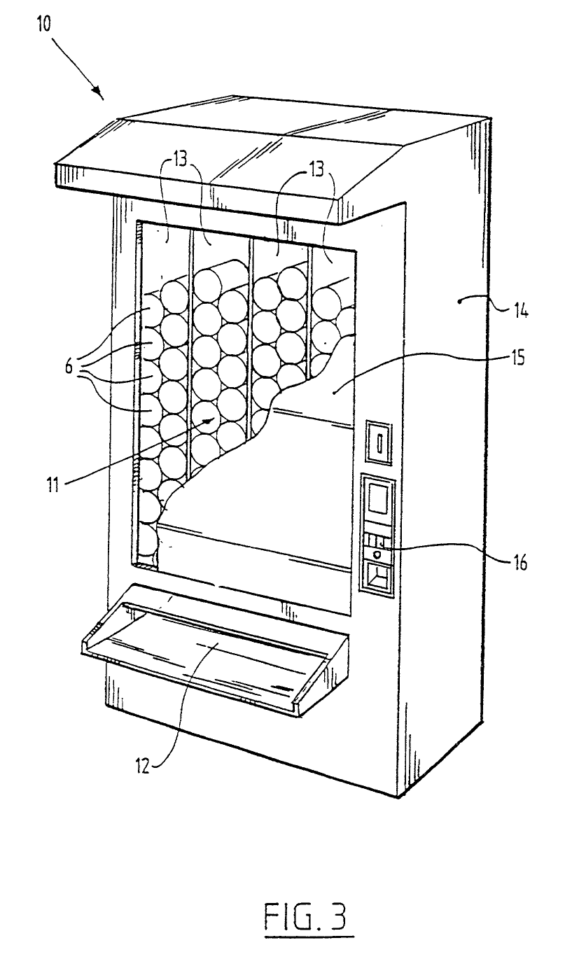

FIG. 3 shows a perspective, partly broken away view of a vending machine filled with a number of containers according to the invention.

The invention relates to a container for bon-bons as a cylindrical can which has the shape and dimensions of a drinks can and is provided with opening means adapted to the bon-bon, and in which at least one bon-bon is packed. The bon-bons themselves are preferably individually packed in the drinks can.

An individually packed bon-bon 1 is obtained for instance by adhering a top foil 2 onto a bottom foil 3.

The inner space 5 is for the greater part taken up by bon-bon 4 and can also be provided with a gas or shock-absorbing cushion of air or an inert gas, for instance N₂, whereby bon-bon 4 is protected in the case of rough movements of the container.

The material of the foil is chosen from aluminum, PE, paper or other material suitable for packaging food products. Known packages, the so-called “flow-pack” with three seals, the “twist” or “double twist” packages, the “bunch” and/or the envelope packages are also suitable for this purpose.

A preferred embodiment of a container according to the invention has the shape and dimensions of a drinks can. The opening means 7, 8 comprise a tab 8 on a cover 7 which can be torn away along a weakening edge. These opening means 7, 8 differ from those for supplying a drink.

The intermediate space 9 in the preferred embodiment of container 6 is filled with a gas, preferably air, whereby a form-rigidity adapted to a vending machine is advantageously obtained in a thin-walled material.

A cylindrical can according to the invention measures for instance about 11 to 14 cm in the lengthwise direction and has a substantially circular end wall with a surface area of 20 to 30 cm².

An embodiment of a vending machine 10 for drinks cans adapted as bon-bon containers 6 has a cooled storage chamber 11.

The dispensing area 12 is situated under storage chamber 11.

Containers 6 are situated lying in columns 13. The cylindrical shape of containers 6 enables simple dispensing.

Storage chamber 11 is closed by means of a housing 14 with a closable door 15 and comprises a cash insertion and validating unit 16.

1. Container filled with at least one bon-bon (4), characterized by a substantially cylindrical can (6) which is provided with a passage for opening which allows through packed or non-packed bon-bons (1); and which has substantially the same form and dimensions as drinks cans sold in vending machines.

2. Container as claimed in claim 1, characterized by a pressure prevailing in the closed container (6) which is greater than 1 atm.

3. Container as claimed in claim 1 or 2, characterized in that the passage is closed by a cover (7) which can be torn away along a weakening line.

4. Container as claimed in any of the foregoing claims, characterized by a plurality of bon-bons (4) which are each provided with an individual packaging (2).

5. Container as claimed in claim 4, characterized in that the individual packaging (2) is advanced as a gas cushion.

6. Vending machine (10) having a cooled storage chamber (11) above a dispensing area (2) which is adapted to dispense cylindrical cans (6) , characterized by comprising at least one container (6) as claimed in any of the foregoing claims.
